(19) United States
(12) Patent Application Publication
(10) Pub. No.: US 2009/0221093 A1
(43) Pub. Date: Sep. 3, 2009

(54) Bio-sample carrier for mass spectrometric analyses

(76) Inventor: Karsten Reihs, Hilden (DE)

Correspondence Address: MCDERMOTT WILL & EMERY LLP, 600 13TH STREET, NW, WASHINGTON, DC, 20005-3096, US

(21) Appl. No.: 11/920,004

(22) PCT Filed: Nov. 16, 2006
(86) PCT No.: PCT/EP2006/003732

§ 371 Date: Feb. 2, 2009

(30) Foreign Application Priority Data
Dec. 5, 2005 (DE) 102005022823.2

(51) Int. Cl. G01N 1/18; B01L 3/00

(52) U.S. Cl. 436/178; 422/100

(57) ABSTRACT

A sample carrier has an ultraphobic surface with an affinity zone and a waste zone and/or a zone occupied by a MALDI matrix. Also disclosed is a process for isolating a substance from a mixture of substances, and for its subsequent treatment, as well as a process for purifying a substance.

The present invention relates to a sample carrier with an ultraphobic surface having an affinity zone and a waste zone and/or a zone occupied by a MALDI matrix. Furthermore, the present invention relates to a method for the isolation of a substance from a substance mixture and its subsequent treatment as well as a method for the purification of a substance.

In the analysis of biomolecules by mass spectrometry by ionisation with matrix-supported laser desorption the substances to be isolated, usually biomolecules, must first be isolated from a substance mixture and/or purified. This is frequently carried out with so-called affinity substances. In the past there has therefore been no lack of attempts to provide sample carriers and/or methods for the isolation/purification of biomolecules prior to their analysis. Mentioned here by way of example are DE 100 43 042 A1, WO94/28418 and WO05/016530. The methods or sample carriers mentioned in these publications, however, have the disadvantage that the sample carriers are either comparatively problematic to produce and/or that the methods undertaken in the isolation/purification are comparatively cumbersome.

The task of the present invention is therefore to provide a sample carrier that does not have the problems of the state of the art.

The task was solved with a sample carrier that has an ultraphobic area, an affinity zone and a waste zone and/or a zone occupied by a MALDI matrix.

It was thoroughly surprising and unexpected for the person skilled in the art that a simple concentration and/or purification of the biomolecules under analysis is possible with the sample carrier according to the invention. The sample carrier according to the invention is simple and cost-effective to produce. In a preferred embodiment of the sample carrier according to the invention it is possible to use the sample carrier for MALDI analysis of the isolated molecules at the same time.

A sample carrier within the meaning of the invention is any arbitrary shaped article with an optionally configured surface. The sample carrier, however, is preferably a plate with a flat surface, most particularly preferably a sample carrier that preferably has no recesses. Most preferably the planar body according to the invention is a film that has an ultraphobic surface. Preferably the surface of the planar body according to the invention is effectively planar; that is it has the surface topography necessary for the ultraphobic surface but no microvolumes in which liquid can accumulate.

According to the invention the planar body has an ultraphobic surface. An ultraphobic surface within the meaning of the invention is characterised in that the contact angle of a water and/or oil drop that lies on the surface is greater than 150°, preferably greater than 160° and most particularly preferred greater than 170° and the roll-off angle does not exceed 10°. The roll-off angle is understood to be the angle of inclination of a fundamentally planar structured surface relative to the horizontal at which a standing water and/or oil drop with a volume of 10 μl moves under gravity on inclining the surface. Such ultraphobic surfaces are disclosed in, for example, WO 98/23549, WO 96/04123, WO 96/21523, WO 99/10323, WO 00/39368, WO 00/39239, WO 00/39051, WO 00/38845 and WO 96/34697, which are herewith introduced as references and thus form part of the disclosure.

In a preferred embodiment the ultraphobic surface has a surface topography at which the spatial frequency of the individual Fourier components and their amplitudes a(f) expressed by the integral S(log(f))=a(f)·f calculated between the integration limits log (f₁/μm⁻¹)=−3 and log (f₂/μm⁻¹)=3 is at least 0.3 and which consists of a hydrophobic or in particular an oleophobic material or is coated with a durable hydrophobic and/or in particular a durable oleophobic material. Such an ultraphobic surface is described in the international patent application WO 00/39240, which is herewith introduced as reference and thus forms part of the disclosure.

Furthermore, according to the invention the sample carrier according to the invention has an affinity zone. The affinity zone serves either to purify a substance mixture and/or to isolate a certain substance from a substance mixture. Substance within the meaning of the invention can comprise one or several molecules. Preferably the molecules are biomolecules such as, for example, proteins, peptides and/or DANN mixtures. The affinity zone preferably has an affinity sorbent for the purification/isolation to which the substances to be removed from the substance mixture are adsorbed and/or to which the substance to be isolated is adsorbed. Thus far spongy microspheres of adsorbent material (Poros, PE, Biosystems) or magnetisable spheres with C4-C18 occupancy for example have proved to be suitable for the purification of peptide/protein or DNA mixtures. The affinity zones can be applied to the sample carrier in a manner familiar to the person skilled in the art. For example, the affinity sorbent can be deposited from the gas phase, whereby the sample carrier is covered with a mask that covers the part of the sample carrier that is not to be coated with the affinity sorbent.

Furthermore, in accordance with the invention the sample carrier in accordance with the invention has a waste zone on which either the drop from which certain molecules have been adsorbed at the affinity zone or the washing liquid that is necessary to purify, for example, the peptide, protein or DNA mixture is removed. According to the invention, the affinity zone<?> is located directly on the sample carrier and preferably in the neighbourhood of the affinity zone.

The affinity zone and the waste zone are preferably separated from one another by an ultraphobic section.

Furthermore, the affinity zone and/or the waste zone are preferably more oleophilic and/or more hydrophilic than the ultraphobic surface. Hydrophilic and/or oleophilic within the meaning of the invention means that a water and/or oil drop may be deposited on these zones; that is, a water and/or oil drop that is suspended a pipetting system is brought into contact with the hydrophilic and/or oleophilic zone, remains attached to it and is thus detached from the pipetting system. A water or oil drop with a volume of 10 μl preferably assumes a contact angle <120°, preferably <110° most especially preferably <90° and/or the roll-off angle of the drop exceeds 10°. Such waste zones can be produce for example by destruction of the ultraphobic coating.

The waste zone is preferably larger than the affinity zone.

Further preferred or according to the invention, the sample carrier has a zone which is occupied by a MALDI matrix.

A MALDI matrix within the meaning of the invention is necessary for carrying out the so-called MALDI mass spectrum that is described, for example, in Nordhoff et al. “MALDI-MS as a new method for the analysis of nucleic acid (DNA and RNA) with molecular masses up to 150,000 Dalton, Application of modern mass spectrometric methods to plant science research, Oxford University Press, (1996) page 86-101.

Preferred MALDI matrices are 3-hydroxypicolinic acid, α-cyano-4-hydroxycinnamic acid, 2,5-dihydroxybenzoic acid, sinapinic acid, 2,4,6-trihydroxyacetopheneone, nitrobenzyl alcohol, nicotinic acid, ferulic acid, caffeic acid, 2-aminobenzoic acid, picolinic acid, 3-aminobenzoic acid, 2,3,4-trihydroxyacetophenone, 6-aza-2-thiothymidine, urea, succinic acid, adipic acid, malonic acid or their mixture. The MALDI matrix is preferably applied to the sample carrier by deposition as disclosed, for example, in DE 102 58 674.8, which is herewith introduced as reference and thus forms part of the disclosure.

The affinity zone is also preferably separated by an ultraphobic section from the zone which is occupied by the MALDI matrix.

A further subject matter of the present invention is a method for the isolation of a substance from a substance mixture and its subsequent processing in which a drop having the substance to be isolated is applied to an affinity zone, the substance to be isolated in the drop (5) is concentrated and the drop is then displaced to another zone and treated with an analysis substance.

It was surprising and thoroughly unexpected for the person skilled in the art that it is possible to isolate a substance from a substance mixture and then process it simply and cost-effectively with the method according to the invention. In respect of the affinity zone and the zone towards which the drop is displaced after concentration reference is made to the aforementioned disclosure.

In the method according to the invention a drop in which a substance mixture is located is applied to an affinity zone. On the affinity zone the molecules that are not to be analysed later and/or would interfere with the analysis are bound as completely as possible, particularly absorbed, so that the substance to be analysed is almost completely isolated. Subsequently the thus isolated and/or purified substance is displaced to another zone that is treated with an analysis substance, preferably a MALDI matrix.

A further subject matter of the present invention is a method for the purification of a substance employing the sample carrier according to the invention, in which a drop having a substance to be isolated is applied to an affinity zone, the substance is immobilised on the affinity zone, preferably bound, the drop is removed and/or a wash liquid is added and the drop and/or wash liquid is removed to the waste zone.

It was surprising and thoroughly unexpected for the person skilled in the art was that the method according to the invention is simple and cost-effective to carry out. In particular, it is possible with the method according to the invention to free a substance from, for example, materials that interfere with the subsequent analysis.

The wash liquid is preferably added in small amounts which form a growing drop on the affinity zone until the largest part of the drop moves from the affinity zone to the waste zone on its own. As soon as the drop has achieved a certain size and/or thus reaches a certain proximity to the waste the drop is almost completely drawn onto the waste zone.

It is further preferred that the addition of the wash liquid takes place repeatedly in succession always when the respective drop has transferred from the affinity zone to the waste zone.

The immobilised substances are preferably remobilised after purification, preferably eluted. The liquid in which these substances are then located is then preferably treated with an analysis substance, for this the drop is preferably displaced onto another zone before the analysis substances is added.

The substance to be purified is preferably a biomolecule and the analysis substance is particularly preferably a MALDI matrix.

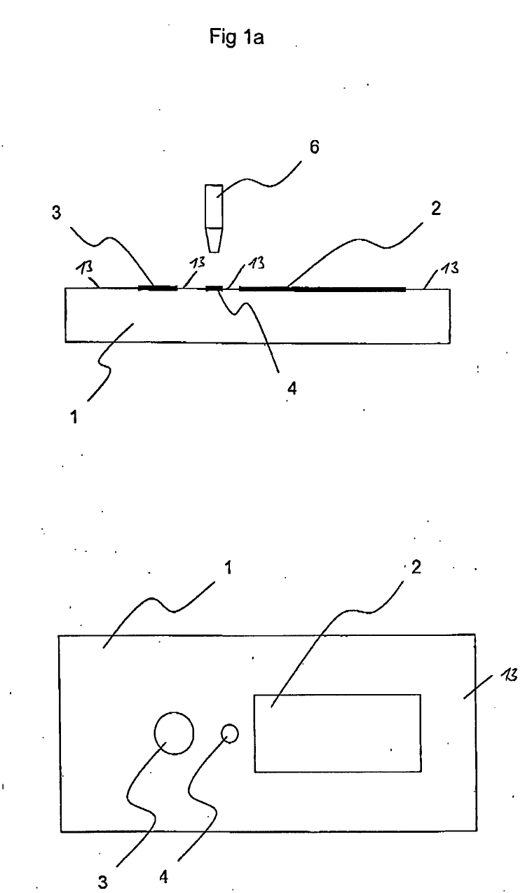

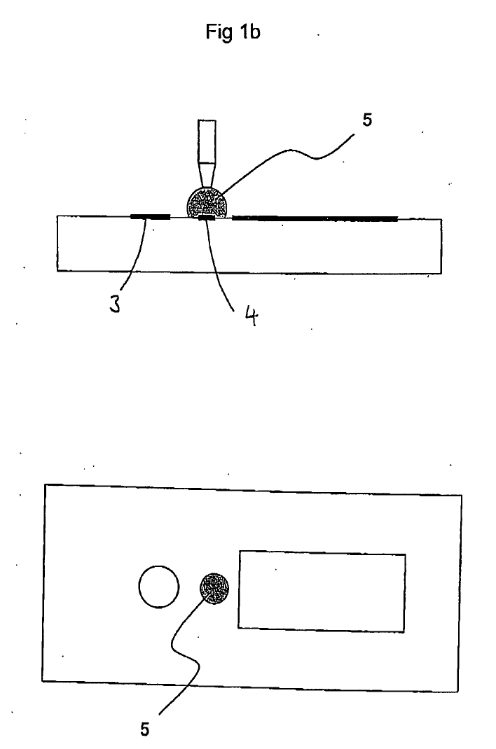

The invention is exemplified in the following by means of the FIGS. 1 to 4. These exemplifications are merely exemplary and do not limit the general inventive concept. The exemplifications apply equally to all invention subject matters.

FIG. 1a shows the sample carrier according to the invention.

FIG. 1b shows an application of a drop to the sample carrier of the invention.

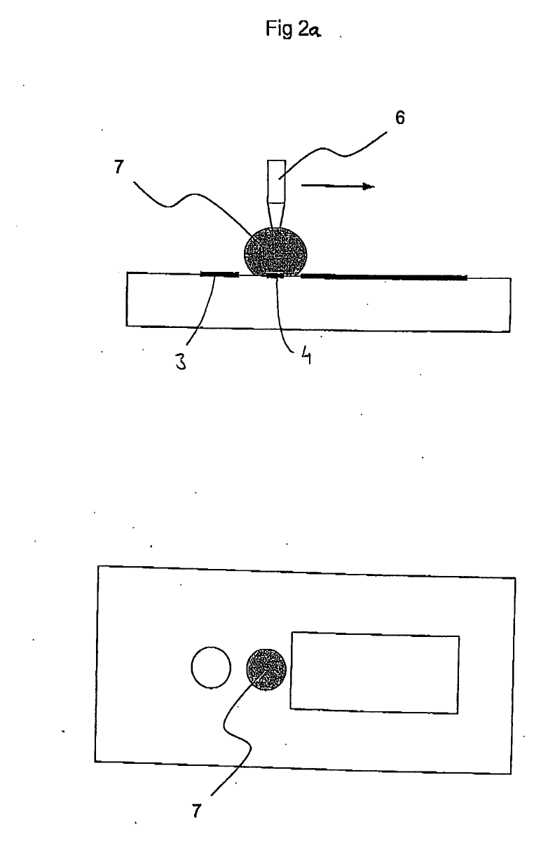

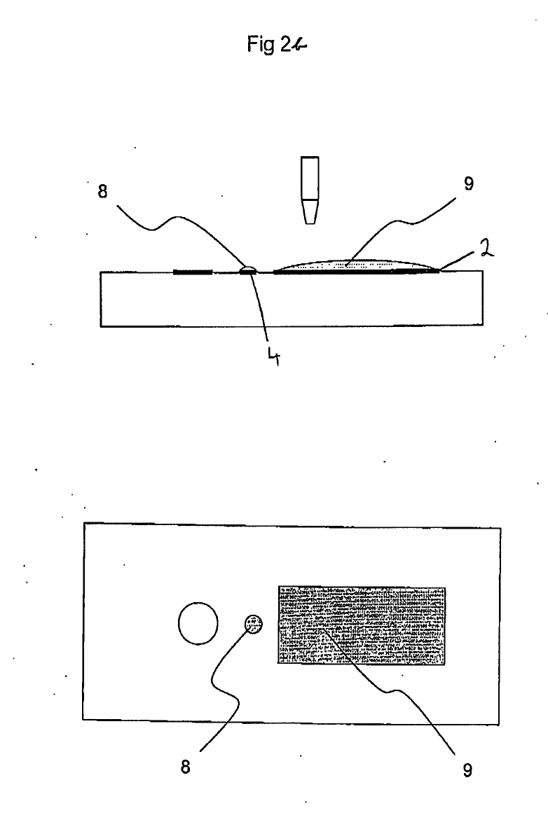

FIGS. 2a and 2b show the purification of adsorbed substances.

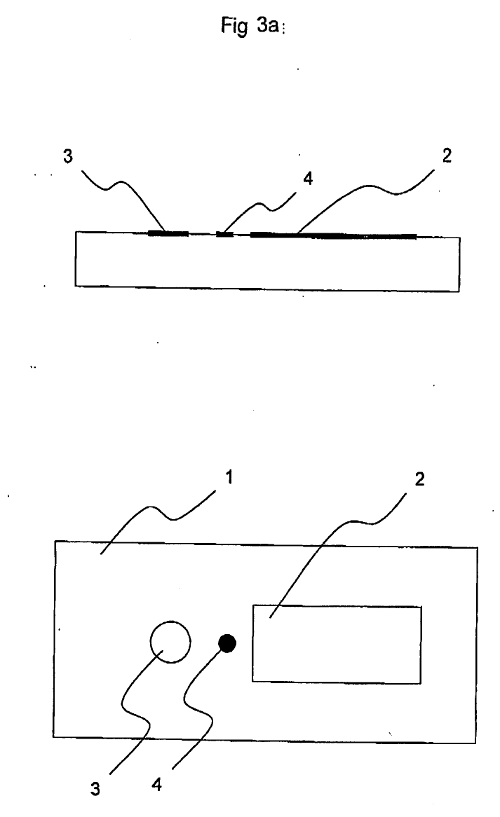

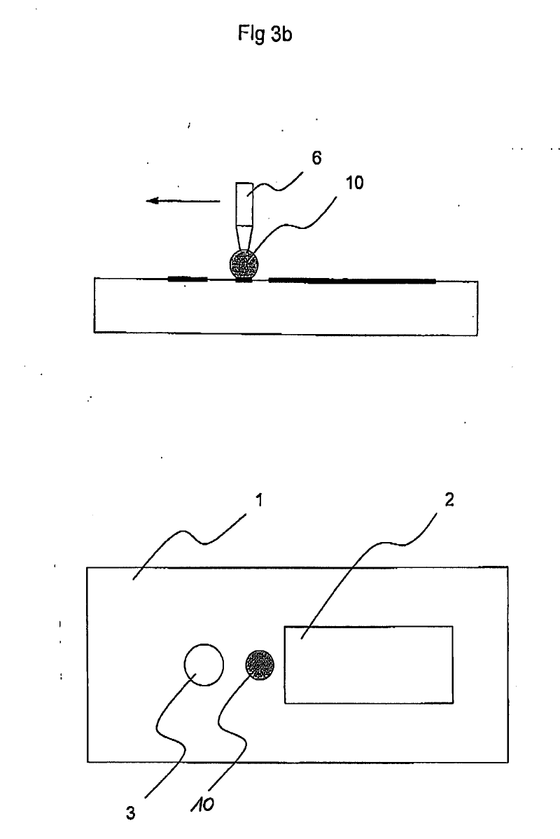

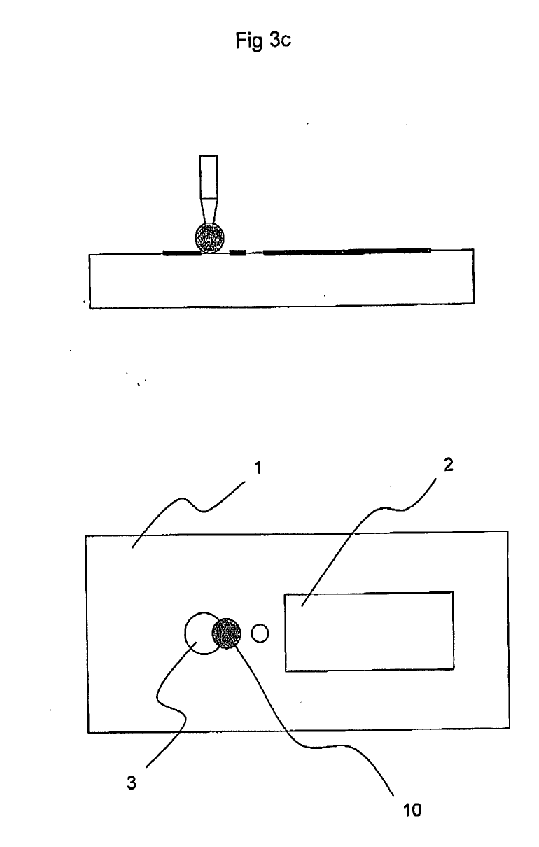

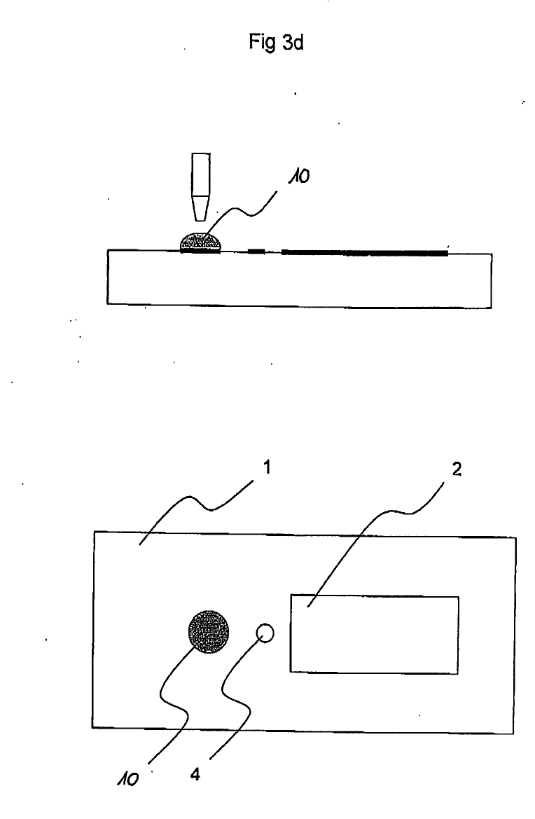

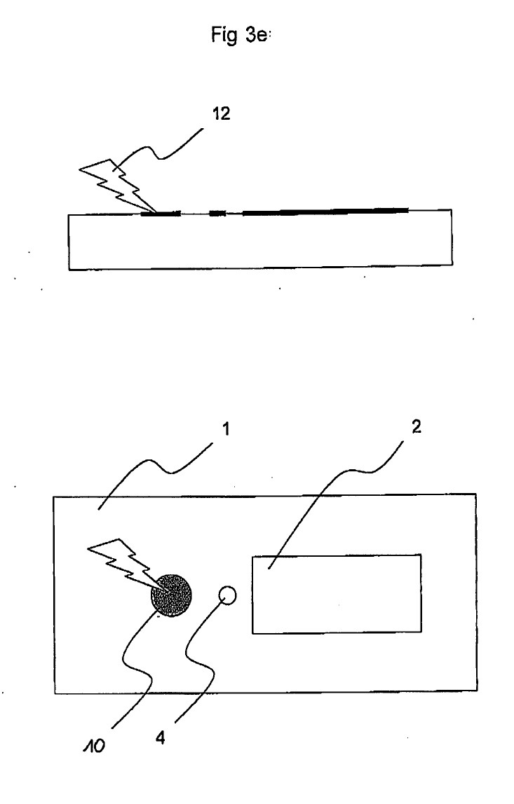

FIG. 3 shows the MALDI analysis of a purified biomolecule.

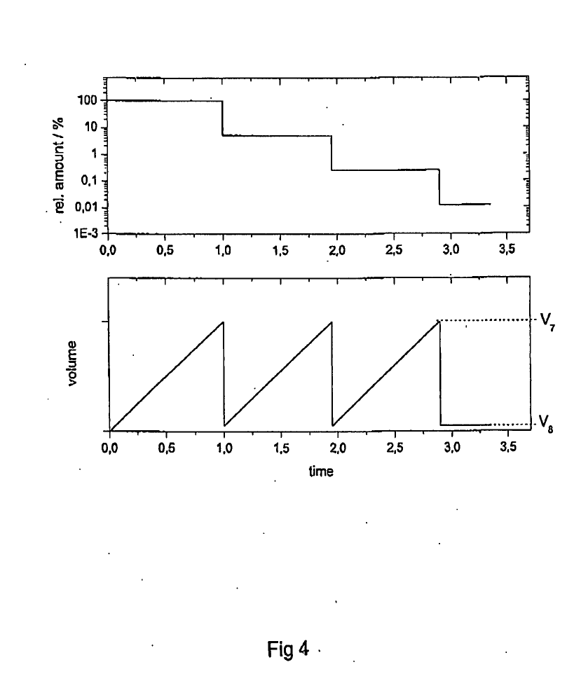

FIG. 4 shows the reduction in impurity through the respective wash cycles.

In FIG. 1a the sample carrier 1 according to the invention which has an ultraphobic surface 13 is illustrated. In addition the sample carrier according to the invention has a waste zone 2, a MATRIX zone 3 as well as an affinity zone 4. Liquids can be applied to the sample carrier, preferably to the affinity zone 4, with a pipette 6, for example a part of a pipette robot. The zones 2, 3, 4 are produced, for example, by separation from the gas phase (deposition) during which the sample carrier has each time different masks which in each case have gaps which correspond in position and size to the respectively desired zone.

The use of the sample carrier according to the invention for concentration of a certain substance, for example a biomolecule in the drop 5, is shown in FIG. 1b. For this the drop 5 is applied to the affinity zone 4 with the pipette 6 and it resides there until the undesired substances in the drop 5 are adsorbed as fully as possible to the affinity zone 4. As shown this drop can be transferred later to the MALDI zone 3 and there analysed.

The purification of a substance with the sample carrier according to the invention is shown in FIGS. 2a and 2b. Firstly a drop is applied to the affinity zone 4 as shown in FIG. 1, and the substance to be purified is adsorbed on the affinity zone 4. Next a wash liquid 7 is applied to the affinity zone with a pipette 6 until as shown by the arrow the drop located there crosses abruptly to the waste zone. This translocation is shown in FIG. 2b. The greater part 9 of the drop 7 is located on the waste zone 2, while only a small liquid fraction 8 remains on the affinity zone 4. This operational sequence can be repeated until the biomolecules adsorbed onto the affinity zone have been sufficiently purified.

The analysis of the purified biomolecules is shown in FIGS. 3a and 3b. These biomolecules are located on the affinity zone (see FIG. 3a). As shown in 3b, an eluate 10 is then applied to the affinity zone 4 with pipette 6 in order to release the biomolecules to be analysed from the affinity zone. After the release has been carried out the drop 10 is drawn from the affinity zone 4 with pipette 6 onto the MATRIX zone 3, as shown by the arrow in FIG. 3b and FIG. 3c. The person skilled in the art recognises that the movement of the drop can also take place by other means. There it next solubilises the MALDI matrix, is then dried however so that the biomolecules to be analysed are incorporated into the MALDI matrix. The crystalline composite of matrix and biomolecule is bombarded with a laser 12 as in FIG. 3e and analysed by the MALDI method.

FIG. 4 shows in the upper part the purification of the substances since the relative fraction of impurity falls in every purification step. The dropwise addition of the wash liquid 7 to volume V₇ and its sudden reduction to Volume V₈ is shown in the lower part of FIG. 4. In this example the wash liquid 7 is added three times.

1. Sample carrier with an ultraphobic surface, characterised in that it has an affinity zone (4) and a waste zone (2) and/or a zone that is occupied by a MALDI matrix.

2. Sample carrier according to claim 1, characterised in that the affinity zone (4) and the waste zone (2) are separated from one another by an ultraphobic section (6).

3. Sample carrier according to claim 1, characterised in that the affinity zone (2) has an affinity sorbent for biomolecules.

4. Sample carrier according to claim 1, characterised in that the affinity zone (4) and the waste zone (2) are more hydrophilic than the ultraphobic surface.

5. Sample carrier according to claim 1, characterised in that the waste zone (2) is larger than the affinity zone (4).

6. Sample carrier according to claim 1, characterised in that it has a zone (3) that is occupied by a MALDI matrix.

7. Sample carries according to claim 6, characterised in that the zone (3) is separated from the affinity zone (4) by an ultraphobic section (6).

8. Method for the isolation of a substance from a substance mixture and its subsequent work-up, characterised in that a drop (5) having a substance to be isolated is applied to an affinity zone (2), the substance to be isolated in the drop (5) is concentrated and the drop is than transferred to another zone (3) and treated with an analysis substance.

9. Method for the purification of a substance using a sample carrier according to claim 8, characterised in that
a drop (5) having a substance to be purified is applied to an affinity zone (2),
the substance is immobilised on the affinity zone (4), preferably bound,
the drop (5) is removed and/or a wash liquid (7) is applied to the affinity zone,
the drop (5) and/or a wash liquid (7) is discarded onto the waste zone.

10. Method according to claim 9 characterised in that the wash liquid is applied in the form of small amounts which form a growing drop on the affinity zone (2) until the larger fraction of the drop transfers itself from the affinity zone (2) to the waste zone (2).

11. Method according to claim 10, characterised in that the addition of the wash liquid is repeated several times.

12. Method according to claim 10, characterised in that the substance is again mobilised, preferably dissolved, after its isolation.

13. Method according to claim 10, characterised in that the isolated substance is treated with an analysis substance.

14. Method according to claim 10, characterised in that the substance is transferred to another zone (3) before the addition of the analysis substance.

15. Method according to claim 8, characterised in that the substance to be isolated is a biomolecule.

16. Method according to claim 8, characterised in that the analysis substance is a MALDI matrix.

17. Method according to claim 11, characterised in that the substance is again mobilised, preferably dissolved, after its isolation.
